(19) United States
(12) Patent Application Publication
(10) Pub. No.: US 2012/0264074 A1
(43) Pub. Date: Oct. 18, 2012

(54) ROTARY HEARTH FURNACE

(75) Inventors: Alfons Gockel, Bochum (DE); Dominikus Schröder, Halver (DE)

(73) Assignee: LOI THERMPROCESS GMBH, Essen (DE)

(21) Appl. No.: 13/407,532

(22) Filed: Feb. 28, 2012

(30) Foreign Application Priority Data
Apr. 13, 2011 (EP) 11 162 322.9

(51) Int. Cl. F27B 7/42; F27D 3/00; F27B 7/34; F27B 7/14; F27B 7/32

(52) U.S. Cl. 432/49; 432/118; 432/112; 432/239

(57) ABSTRACT

In the case of a rotary hearth furnace of annular construction for the heat treatment of workpieces, which has a furnace chamber, an annular rotary hearth, a rotary drive which drives the rotary hearth and a plurality of racks for receiving or supporting workpieces, which are arranged on the annular rotary hearth and are provided with receiving elements, which divide a respective rack into at least two horizontal planes for receiving workpieces, the intention is to provide a solution which makes extremely uniform heating of the workpieces to be heattreated in the furnace chamber possible in a structurally simple and cost-effective manner. This is achieved in that provision is made, at least between two horizontal planes of a respective rack, of at least one additional heating apparatus which heats the workpieces held in the corresponding horizontal planes.

The invention relates to a rotary hearth furnace of annular construction for the heat treatment of workpieces, comprising an outer and inner wall, which delimit a furnace chamber having at least one treatment zone, at least one heating apparatus which heats the furnace chamber, an annular rotary hearth and a rotary drive which drives the rotary hearth, wherein the outer wall has at least one closable opening for loading and/or unloading the furnace chamber, wherein a plurality of racks for receiving or supporting workpieces are arranged and fitted circumferentially on the annular rotary hearth, wherein a respective rack is provided with receiving elements, which divide the rack into at least two horizontal planes for receiving workpieces such that they are arranged lying one above another, wherein at least one workpiece can be received in each horizontal plane.

To establish defined workpiece properties, for example a high hardness and/or a high creep rupture strength or yield strength, a workpiece, for example boron-alloyed heat-treatable steels (22MnB5), is subjected to heat treatment, for example heating/austenitization. To date, the heat treatment of workpieces, for example of coated and uncoated steel sheet blanks (e.g. boron-alloyed heat-treatable steels), before press hardening has been effected in a roller hearth furnace, where use is made of ceramic conveyor rollers for transporting the steel sheet blanks through the furnace chamber. However, it has been found that heating of the steel sheet blanks in the temperature range between 450° C. and 750° C. gives rise to a reaction between the then liquid Al—Si coating of the steel sheet blanks and the rollers. The metal/metal oxide mixtures which form in this case infiltrate into the rollers and damage the latter, leading to breakage. As an alternative to a roller hearth furnace, such heat treatments to be performed on steel sheet blanks can also be carried out in a rotary hearth furnace, which is distinguished by its space-saving construction. In this type of furnace, the workpieces or steel sheet blanks are not transported using rollers during the heat treatment, but instead are introduced into the furnace chamber via an opening and set down on appropriately formed racks arranged on the rotary hearth in the furnace chamber for heat treatment. A rotary hearth furnace of the type indicated in the introduction is known, for example, from DE 10 2007 048 041 A1, in which a plurality of workpieces are arranged on a respective rack in a manner lying radially one behind another with respect to the circumference of the rotary hearth furnace. In order furthermore to exhibit an identical throughput rate as compared with roller hearth furnaces, it is known to configure racks or charging racks in such a manner that a plurality of workpieces can be arranged in a rack in a plurality of horizontal planes or rack planes which lie one above another for heat treatment.

As mentioned above, uniform and homogeneous heating of the workpieces is required during the heat treatment for establishing defined workpiece properties. However, if the workpieces to be heat-treated are arranged lying one above another in a plurality of rack planes, uniform heating of the workpieces in the central planes is problematic. Although the wall of the furnace chamber comprehensively radiates the heat emitted by the heating apparatus arranged in the furnace chamber, a situation where, for example, four layers of workpieces in the form of steel sheet blanks are arranged lying one above another gives rise to the problem that the reflected heat radiation only reaches the steel sheet blanks arranged on the central rack planes to an inadequate extent, and therefore it is necessary to increase the residence time of the workpieces in the furnace chamber, so that the workpieces in the central horizontal or rack planes also experience the desired heating, which entails higher operating and production costs.

It is therefore an object of the invention, in the case of a rotary hearth furnace of the type indicated in the introduction, to provide a solution which makes extremely uniform heating of the workpieces to be heat-treated in the furnace chamber possible in a structurally simple and cost-effective manner, to be precise under conditions which are favorable in terms of manufacturing and operation.

In the case of a rotary hearth furnace of the type indicated in the introduction, this object is achieved according to the invention in that provision is made, at least between two horizontal planes of a respective rack, of at least one additional heating apparatus, which heats the workpieces held in the corresponding horizontal planes, is a component part of the rotary hearth furnace and is fitted to the rotary hearth in an appropriate manner. The rack is a component part of the rotary hearth furnace and is fitted to the rotary hearth, it being possible, for example, for the rack to be fitted to the rotary hearth in the furnace chamber so as to be removable, in such a manner that workpieces can be introduced into the furnace chamber and removed therefrom together with the rack. Furthermore, the additional heating apparatus can be a component part of the rotary hearth furnace and can be fitted to the rotary hearth or else to the rack.

Advantageous and expedient configurations and developments of the invention become evident from the dependent claims.

The invention makes it possible for workpieces to be heat-treated in a high volume with a high throughput rate in a structurally simple and cost-effective manner. The rack makes it possible for a plurality of workpieces to be received, with the workpieces being held by a respective rack both lying alongside one another and lying one above another. The provision, at least between two horizontal planes of a rack, of at least one additional heating apparatus which heats the workpieces held in the corresponding horizontal planes ensures uniform heating of the workpieces for a minimum residence time of the workpieces in the furnace chamber. The residence time of the workpieces in the furnace chamber therefore primarily addresses the quality of the materials to be treated, and is not dependent on a possibly unfavorable arrangement of individual workpieces with respect to the primary heating apparatus.

A respective rack can consist of struts, fired shaped bodies or fired profiles and/or comprise a grating for each horizontal plane for receiving workpieces. On account of the intended use of a respective rack at high temperatures in the furnace chamber, it is advantageous if a respective rack is produced from silicon carbide (SiC) or from heat-resistant steel.

The additional heating apparatus can be connected to the rack via ceramic insulators on the basis of aluminum oxide (Al₂O₃) or zirconium oxide (ZrO₂). The additional heating apparatus can therefore be part of the rack arranged on the rotary hearth or alternatively can be arranged and fitted on the rotary hearth between two rack planes via a separate mount.

One configuration of the invention furthermore provides that the at least one additional heating apparatus is an electrically operated heating apparatus, which is electrically connected to at least one busbar running beneath the rotary hearth. The at least one additional heater provided for a rack is controlled or regulated independently or separately of the control or regulation of the primary heating apparatus in the furnace chamber, which can be in the form of a plurality of radiant heating tubes or of a direct heater, which can be arranged running vertically or horizontally in the furnace chamber.

It is particularly advantageous if the at least one additional heating apparatus is in the form of a two-dimensional element which extends between the horizontal planes. In other words, the at least one additional heater provided for each rack is formed between two horizontal receiving regions or surfaces across the whole area of the receiving regions, such that the heat emitted by the additional heating apparatus is oriented both to the bottom side of the workpieces arranged above the additional heating apparatus and to the top side of the workpieces arranged beneath the additional heating apparatus, and can heat said workpieces. Alternatively, the additional heating apparatus can extend only over a core or central surface of the adjacent workpieces, such that only the core region of the workpieces is heated by the additional heating apparatus.

In order to keep the structural outlay for the rotary hearth furnace low, a further configuration of the invention provides that a further additional heating apparatus is arranged beneath the lowermost horizontal plane of a respective rack and is in the form of a two-dimensional element which extends between the lowermost horizontal plane and the rotary hearth, in order to compensate for the heat losses of the base of the furnace chamber.

Particularly efficient heating of the workpieces on horizontal planes which are not irradiated directly by the heating apparatus is made possible, in one configuration of the invention, by the fact that the heating power of the at least one additional heating apparatus can increase concentrically from outside inward for a corresponding horizontal plane in the vicinity of which said apparatus extends. Whereas some of the heat radiation from the primary heating apparatus can arrive at the outer regions of the workpieces of the horizontal planes arranged between the lowermost and topmost horizontal planes, this heat radiation does not pass into the central region of the rack or charging rack, particularly if the workpieces have a plate-like form. Efficient and cost-effective heating of these central regions can therefore be made possible by forming the additional heating apparatus in such a manner that the central regions can be heated to a greater extent than the outer regions.

A particularly efficient use of the additional heating apparatus is made possible by the fact that the latter is active only in accordance with the heat treatment cycle. Therefore, a further configuration of the invention provides that the temperature of the additional heating apparatus is set depending on the treatment zone. It is thereby possible for the additional heating apparatus to be operated at full power for heating the workpieces in a treatment zone intended as a heating zone in a first step, in addition to the primary heating apparatus, whereas the power of the additional heating apparatus is adapted and reduced in a treatment zone intended as a holding zone.

In this respect, it is advantageous if a respective additional heating apparatus is assigned at least one thermocouple for regulating the temperature of the additional heating apparatus, or a heating manipulated variable is predefined via a prescription. If a thermocouple is used, the power of a respective additional heating apparatus can thereby not only be set depending on the treatment zone, but also in particular can be set to the power required for uniform heating. The use of a prescription, which is a set of functionally and/or procedurally related parameters, for predefining the heating manipulated variable or power control of the additional heating apparatus makes it possible to obtain a heat treatment process which is automated and reproducible to the greatest possible extent.

With a view to reducing the heat losses of the rotary hearth furnace when loading workpieces into and unloading workpieces from the furnace chamber, it is particularly advantageous if the at least one closable opening for loading and/or unloading the furnace chamber is in the form of a vertically movable slotted door, through which workpieces for a corresponding horizontal plane of the rack can be introduced into the furnace chamber or removed from the furnace chamber.

It is self-evident that the features mentioned above and the features yet to be explained below can be used not only in the respectively specified combination but rather also in other combinations or individually without departing from the scope of the present invention. The scope of the invention is defined only by the claims.

Further details, features and advantages of the subject matter of the invention will emerge from the following description in conjunction with the drawing, in which exemplary embodiments of the invention are illustrated.

In the drawing:

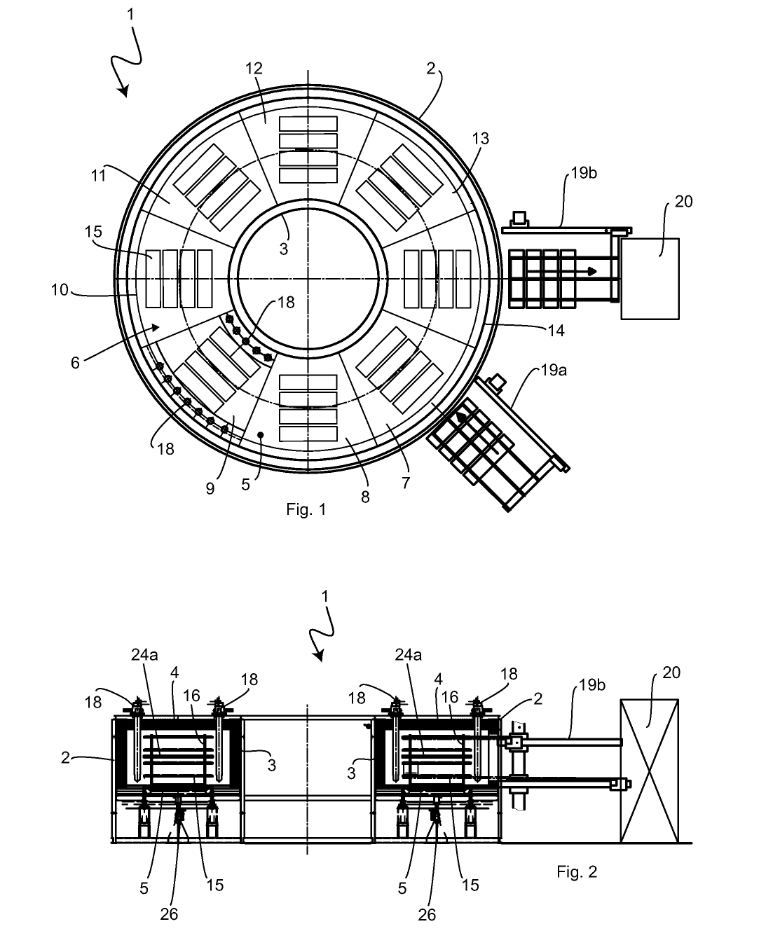

FIG. 1 shows a schematic plan view of a rotary hearth furnace according to the invention,

FIG. 2 is a schematic sectional illustration of the rotary hearth furnace shown in FIG. 1, in a side view,

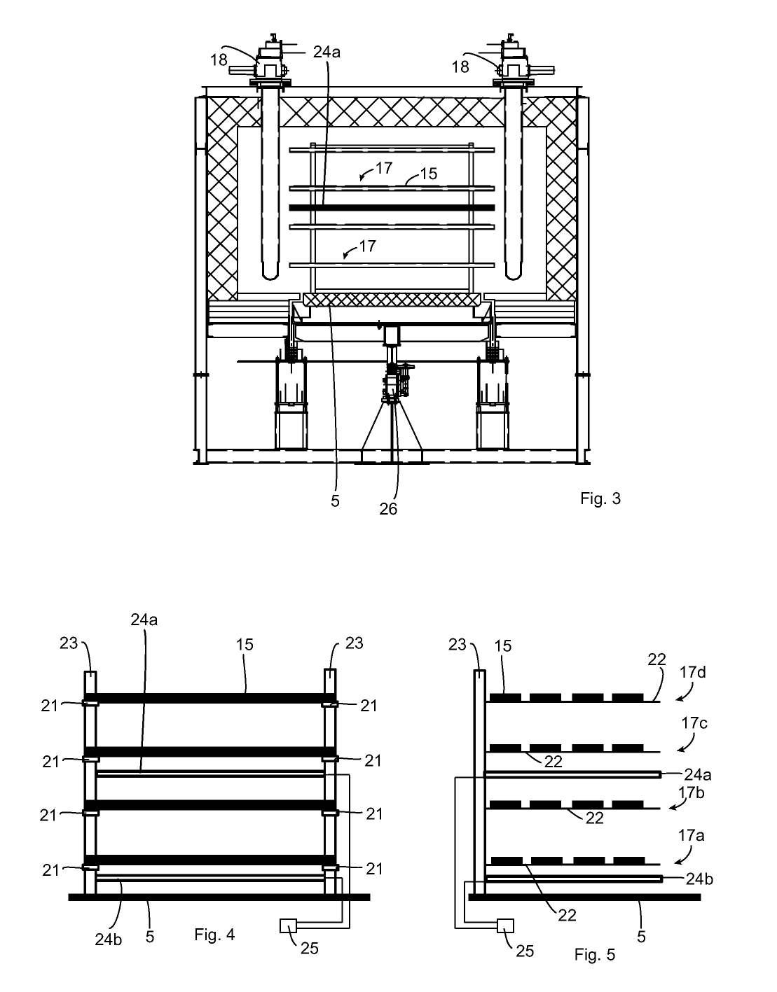

FIG. 3 shows an enlarged section of the rotary hearth furnace shown in FIG. 2,

FIG. 4 shows an exemplary design of a rack of the rotary hearth furnace, in a view from the front, and

FIG. 5 shows a side view of the rack shown in FIG. 4.

A rotary hearth furnace 1 of annular construction according to the invention, which is shown in a plan view in FIG. 1 and in a sectional view from the side in FIG. 2, comprises an outer wall 2 and an inner wall 3, which are stationary and consist of refractory masonry. A stationary cover wall 4, which is fixedly connected to the outer and inner walls 2 and 3, and a rotary hearth 5, which has an annular form and can be driven rotatably by a rotary drive (not shown in more detail) and is supported on supporting rollers 26, delimit an annular furnace chamber 6. The furnace chamber 6 is divided into different treatment zones, where individual zones can be formed and/or can be separated from one another with the aid of insulated intermediate walls (not shown in more detail) installed on the rotary hearth 5. The schematically shown rotary hearth furnace 1 has a loading zone 7, three heating zones 8, 9 and 10, three holding zones 11, 12 and 13, and a removal zone 14. In the loading zone 7, a closable opening is provided in the outer wall 2, through which opening individual workpieces 15 are introduced into the furnace interior 6 by means of a manipulator 19a. A rack 16 for receiving or supporting the workpieces 15 is provided in each zone in the furnace chamber 6. As can be seen from FIGS. 1 and 2, the workpieces 15 have a plate-like form, these in the specific case being steel sheet blanks. Here, a respective rack 16, which is shown in more detail in FIGS. 2 to 5, receives in each case four workpieces 15 in a horizontal plane 17, the workpieces 15 being arranged lying radially from the inside outward. An arrangement of the workpieces 15 which differs therefrom is of course also conceivable, it also being possible, depending on the outer dimensions of the workpiece to be heat-treated, for only a single workpiece 15 to be held or supported in a rack plane or horizontal plane 17 of the rack 16. The racks 16 are arranged or fastened on the annular rotary hearth 5 circumferentially or around the circumference thereof, and permanently remain in the furnace chamber 6. The workpieces 15 are heated in the heating zones 8, 9, 10, provision being made for this purpose of a heating apparatus 18 in the form of a plurality of radiant heating tubes. Once the workpieces have passed through the heating zones 8, 9, 10, they pass into the so-called holding zones 11, 12, 13, in which temperature equalization takes place in the workpieces 15. Once they have passed through the holding zone 13, the workpieces 15 are then arranged in a removal zone 14, where they are removed from the furnace chamber 6 from an opening in the outer wall 2 of the rotary hearth furnace 1 with the aid of a manipulator 19b and then provided in centered fashion for transfer to the press. In this case, the manipulator 19b can be designed such that all workpieces 15 of a horizontal plane are simultaneously conveyed out of the furnace chamber 6.

As can be gathered in particular from FIGS. 3 to 5, a respective rack 16 has a plurality of horizontal planes 17 or 17a, 17b, 17c, 17d, so that workpieces 15 can be held or supported by a rack 16 so as to lie not only alongside one another but also one above another. In this case, a respective rack can consist of struts, fired shaped bodies or fired profiles and/or comprise a grating for each horizontal plane for receiving workpieces, it being possible for the rack 16 to be in the form of a four-legged frame with vertical supports and corresponding horizontal struts which connect the vertical supports and form the horizontal planes. On account of the high temperatures which prevail in the furnace chamber 6, the racks 16 are preferably produced from silicon carbide or from a heat-resistant steel or from some other ceramic material.

A respective rack 16 has receiving elements 21, which can either be adapted to the shape of the workpiece 15 to be held or to be supported or can have a shape which is formed for universally supporting differently shaped workpieces 15. In the case of the embodiment of a rack 16 as shown in FIGS. 4 and 5, the individual horizontal planes 17a, 17b, 17c, 17d are defined by the corresponding receiving elements 21, which, in this exemplary embodiment, are in the form of horizontal struts 22 which extend from corresponding vertical struts 23 and on which the workpieces 15 can be set down such that they lie alongside one another and one above another. The horizontal struts 22 therefore represent load-bearing support or carrier elements for supporting the respective longitudinal ends of the workpieces 15. It should be noted once again that the embodiment of a respective rack 16 as shown in FIGS. 4 and 5 is chosen merely by way of example, and a respective rack 16 can have a structure which differs therefrom as long as appropriate receiving elements 21 which make it possible to horizontally and vertically receive workpieces are provided, wherein the receiving elements 21 divide the rack 16 into at least two horizontal planes 17a, 17b, 17c, 17d for receiving workpieces 15 such that they are arranged lying one above another. In this case, each rack plane or horizontal plane 17a, 17b, 17c, 17d can receive at least one workpiece 15.

According to the invention, provision is made for at least one additional heating apparatus 24a to be arranged at least between two horizontal planes 17, the horizontal planes 17b and 17c in FIGS. 4 and 5, of a respective rack 16. The additional heating apparatus 24a is a component part of the rotary hearth furnace 1 and is fitted or fastened to the rotary hearth 5 and/or to a respective rack 16. Alternatively, the additional heating apparatus 24a can also be fastened to the rack 16, if the rack 16 is a component part of the rotary hearth furnace 1 and is fitted to the rotary hearth 5. In this way, the additional heating apparatus 24a and the rack 16 are then component parts of the rotary hearth furnace 1. In a further, alternative configuration, in which the rack 16 and the additional heating apparatus 24a are still both component parts of the rotary hearth furnace 1 and belong thereto, the rack 16 and the additional heating apparatus 24a can be fitted separately to the rotary hearth 5, in which case the rack 16 can be fitted to the rotary hearth 5 in the furnace chamber 6 such that it can be removed, in such a manner that workpieces 15 can be introduced into and removed from the furnace chamber 6 together with the rack 16, whereas the additional heating apparatus 24a remains around the furnace chamber 6. However, it is preferable for both a respective rack 16 and a respective additional heating apparatus 24a to be fitted or fastened to the rotary hearth 5 and for merely the workpieces to be introduced into and removed from the furnace chamber 6, whereas a respective rack 16 and a respective additional heating apparatus 24a remain permanently in the furnace chamber 6 and form component parts of the rotary hearth furnace 1. As is evident from FIG. 3, the radiation of the radiant heating tubes which are in the form of a heating apparatus 18 acts only in the lateral regions of the workpieces, with the base and the cover of the furnace chamber 6 being formed in such a manner that the heat radiation of the heating apparatus 18 is reflected and passes onto those surfaces of the bottom or top workpiece 15 which are directed toward the base or toward the cover. Although this ensures that the bottom workpiece 15 and the top workpiece 15 are heated, the radiation does not pass to the central workpieces 15, and therefore the heating thereof is delayed greatly compared to the bottom and top workpieces. In order to prevent this and to make the heating temporally more uniform, the invention provides the additional heating device 24a, which is arranged between the two horizontal planes 17b and 17c and additionally heats those surfaces of the workpieces 15 of the central horizontal planes 17b and 17c which were not sufficiently irradiated with heat previously. In this case, the additional heating apparatus 24a can be a part of the rack 16 arranged on the rotary hearth 5 or can be fitted on the rotary hearth 5 between two horizontal planes 17b and 17c of the rack 16 via a separate mount.

It goes without saying that an additional heating apparatus 24a as described above can also additionally or alternatively be arranged between the horizontal planes 17a and 17b and/or 17c and 17d, in order to make the heating of the workpieces 15 more uniform. It is also conceivable—as shown by way of example in FIGS. 4 and 5—for a further additional heating apparatus 24b to be arranged beneath the lowermost horizontal plane 17a of a respective rack 16, extending between the lowermost horizontal plane 17a and the rotary hearth 5 as the base of the furnace chamber 6. The region of the rotary hearth 5 usually represents a heat sink, which can be counteracted with the aid of the additional heating apparatus 24b.

The additional heating apparatuses 24a or 24b can be connected to the rack 16 via ceramic insulators on the basis of aluminum oxide (Al₂O₃) or zirconium oxide (ZrO₂) and can each be in the form of an electrically operated heating apparatus, which is electrically connected to at least one busbar 25 running beneath the rotary hearth 5. At least one of the two additional heating apparatuses 24a, 24b for a respective rack 16 can be in the form of a two-dimensional element which comprehensively covers the region of the workpieces 15 received by the rack 16. This ensures that the entire top or bottom side surface of a workpiece 15 is irradiated with heat by the additional heating apparatus 24a, 24b. If the additional heating apparatus 24a, 24b has a two-dimensional form, it is then optionally possible to configure the additional heating apparatus in such a manner that the heating power of the additional heating apparatus 24a, 24b can increase concentrically from outside inward for a corresponding horizontal plane 17 in the immediate vicinity of which said apparatus extends, such that rapid heating of the center of the workpiece 15 is also ensured. By way of example, the additional heating apparatuses 24a, 24b can be in the form of an electric heating coil, in which case the inner portions of the electric heating coil are arranged so as to lie closer to one another for increasing the power. In this case, the additional heating apparatuses 24a, 24b or only the additional heating apparatus 24a can be operated depending on the treatment zone, and therefore it is conceivable, for example, for the additional heating apparatus 24a to be in operation only in the heating zones 8, 9 and 10 or only in the holding zone 11, 12, 13, in order to ensure temperature equalization in the workpieces 15 of the central horizontal planes 17b and 17c. Alternatively, a respective additional heating apparatus 24a or 24b can be assigned a thermocouple (not shown in more detail in the figures) for regulating the temperature, such that the heating power of the additional heating apparatus 24a or 24b is independent of the treatment zone and is set purely on the basis of the actual heating of the workpiece 15.

In summary, the present invention relates to a rotary hearth furnace 1 for heating coated and uncoated steel sheet blanks before the treatment step of hot forming or press hardening. In the case of the rotary hearth furnace 1 according to the invention, the steel sheet blanks are charged as workpieces 15 into individual racks or receiving racks 16. For this purpose, in each case a separate loading apparatus and removal apparatus with a manipulator 19a and 19b, respectively, is arranged upstream of the rotary hearth furnace 1. The removal apparatus is additionally equipped with a unit for centering the heated steel sheet blanks. Each rack 16 has at least two horizontal planes 17, each horizontal plane 17 being capable of receiving at least one workpiece 15. The rack is produced from silicon carbide (SiC), alternatively from steel resistant to high temperatures, or a ceramic material. The rotary hearth furnace 1 has a number of heating zones 8, 9, 10 and holding zones 11, 12, 13 which is matched to the power, and furthermore a space for charging 7 and a space for discharging 14. The furnace chamber 6 is heated using a heating apparatus 18, e.g. indirectly via radiant heating tubes installed perpendicularly in the cover of the furnace chamber 6, where for reasons of clarity the heating apparatuses 18 only for the heating zone 9 are shown graphically in FIG. 1. In order to achieve the most accurate and homogeneous temperature distribution possible in the workpieces 15 over all horizontal planes 17 of the rack 16, an additional heating apparatus 24a, for example in the form of electric heating elements, is arranged at least between two horizontal planes 17 of the rack 16. The energy for the, for example electric, additional heating apparatus 24a is tapped off from one or more busbars 25 beneath the rotary hearth 5. In this case, electric power is supplied to all the additional heating apparatuses 24a of the rotary hearth furnace 1 centrally, whereas the respective additional heating apparatuses 24a can be regulated in a decentralized manner. In this case, the respective additional heating apparatuses 24a can have a two-dimensional form, in such a manner that the power can be increased concentrically inward. The power is regulated or controlled either via direct regulation depending on the temperature in the more immediate surroundings of the workpiece 15, via an indirect zone manipulated variable or via fixedly predefined prescriptions depending on the workpiece 15 to be heated. To compensate for the energy sink or heat sink which is usually located at the base of the furnace chamber 6, a further additional heating apparatus 24b can also be provided beneath the lowermost horizontal layer 17a of the rack 16. The regulation to nominal material temperature of the workpiece 15 is effected via at least one appropriate thermocouple, which is carried along in the region of the corresponding additional heating apparatus 24a or 24b. The position of the thermocouple is chosen such that the thermocouple lies primarily in the region of radiation influence of the workpiece 15 and of the additional heater 24a or 24b. The thermocouple only regulates the power output of the electric additional heating apparatus 24a or 24b, whereas the main or primary heating apparatus 18 is implemented by regulation which is independent of the electric additional heating apparatus 24a or 25b.

In relation to the loading zone 7 and the removal zone 14, it should be noted that the corresponding closable opening for loading and/or unloading the furnace chamber 6 can be in the form of a vertically movable slotted door, through which the workpieces 15 for a corresponding horizontal plane 17 of the rack 16 can be introduced into the furnace chamber 6 or removed from the furnace chamber 6. For charging and discharging only one horizontal plane 17 in a rack 16, the opening in the slotted door, which can be closed with a pneumatic or electromotive slide, is positioned in front of the respective horizontal plane 17 of a respective rack 16 with a rack and pinion drive or alternatively a chain.

It is self-evident that the invention described above is not restricted to the embodiments described and illustrated. Numerous modifications which are obvious to a person skilled in the art in accordance with the intended application may be made to the embodiments illustrated in the drawing without thereby departing from the scope of the invention. Here, the invention includes all of that which is contained in the description and/or illustrated in the drawing, including that which, outside the specific exemplary embodiments, is obvious to a person skilled in the art.

1. Rotary hearth furnace of annular construction for the heat treatment of workpieces, comprising an outer and inner wall, which delimit a furnace chamber having at least one treatment zone, at least one heating apparatus which heats the furnace chamber, an annular rotary hearth and a rotary drive which drives the rotary hearth,
wherein the outer wall has at least one closable opening for loading and/or unloading the furnace chamber,
wherein a plurality of racks for receiving or supporting workpieces are arranged circumferentially on the annular rotary hearth, and
wherein a respective rack is provided with receiving elements, which divide the rack into at least two horizontal planes for receiving workpieces such that they are arranged lying one above another, wherein at least one workpiece can be received in each horizontal plane,
and further wherein
provision is made, at least between two horizontal planes, of a respective rack, of at least one additional heating apparatus which heats the workpieces held in the corresponding horizontal planes.

2. Rotary hearth furnace according to claim 1, wherein a respective rack is produced from silicon carbide or from heat-resistant steel.

3. Rotary hearth furnace according to claim 1, wherein the at least one additional heating apparatus is an electrically operated heating apparatus, which is electrically connected to at least one busbar running beneath the rotary hearth.

4. Rotary hearth furnace according to claim 1, wherein the at least one additional heating apparatus is in the form of a two-dimensional element which extends between the horizontal planes.

5. Rotary hearth furnace according to claim 1, wherein a further additional heating apparatus is arranged beneath the lowermost horizontal plane of a respective rack and is in the form of a two-dimensional element which extends between the lowermost horizontal plane and the rotary hearth.

6. Rotary hearth furnace according to claim 4, wherein the heating power of the at least one additional heating apparatus can increase concentrically from outside inward for a corresponding horizontal plane in the vicinity of which said apparatus extends.

7. Rotary hearth furnace according to one of the claim 1, wherein the temperature of the additional heating apparatus is set depending on the treatment zone.

8. Rotary hearth furnace according to claim 1, wherein a respective additional heating apparatus is assigned at least one thermocouple for regulating the temperature of the additional heating apparatus, or a heating manipulated variable is predefined via a prescription.

9. Rotary hearth furnace according to one of the claim 1, wherein the at least one closable opening for loading and/or unloading the furnace chamber is in the form of a vertically movable slotted door, through which workpieces for a corresponding horizontal plane of the rack can be introduced into the furnace chamber or removed from the furnace chamber.
